(19) United States
(12) Patent Application Publication
(10) Pub. No.: US 2013/0020085 A1
(43) Pub. Date: Jan. 24, 2013

(54) SURFACTANT SYSTEM TO INCREASE HYDROCARBON RECOVERY

(71) Applicants: Jean Denis PONE, Bartlesville, OK (US); David J. BLUMER, Bartlesville, OK (US)

(72) Inventors: Jean Denis PONE, Bartlesville, OK (US); David J. BLUMER, Bartlesville, OK (US)

(73) Assignee: CONOCOPHILLIPS COMPANY, Houston, TX (US)

(21) Appl. No.: 13/537,268

(22) Filed: Jun. 29, 2012

Related U.S. Application Data
(60) Provisional application No. 61/509,921, filed on Jul. 20, 2011.

(51) Int. Cl. C09K 8/68; E21B 43/25

(52) U.S. Cl. 166/305.1; 507/209; 166/369

(57) ABSTRACT

A post-primary oil recovery process for recovering oil from a subterranean formation may involve injecting into a crude oil-bearing subterranean formation an aqueous saline surfactant composition of brine, Alkyl Polyglucoside, Linear Primary Alcohol Ethoxylate, sodium hydroxide and alcohols; displacing the aqueous composition through the oil-bearing formation and driving oil from the oil-bearing formation; and recovering oil displaced from the subterranean formation. The injecting step may be preceded by the step of injecting into the subterranean formation a volume of salinity water to adjust salinity of connate water within the subterranean reservoir to a predetermined salinity. Injection of the surfactant composition may further be followed by injection of a buffer comprising water dispersible polymeric viscosifier or water soluble polymeric viscosifier. The surfactant composition may additionally contain at least one cosurfactant selected from hydrocarbon sulfonates and alcohols. The aqueous saline surfactant composition may be or include SCHMOO-B-GONE SURFACTANT®.

### CROSS-REFERENCE TO RELATED APPLICATIONS

This application claims priority benefit under 35 U.S.C. Section 119(e) to U.S. Provisional Patent Ser. No. 61/509,921 filed on Jul. 20, 2011 the entire disclosure of which is incorporated herein by reference.

### FIELD OF THE INVENTION

This disclosure relates to a method of improving post-primary oil recovery by using a surfactant system.

### BACKGROUND OF THE INVENTION

Water flooding is a method that may be used in a post-primary oil recovery process to recover additional volumes of petroleum from a subterranean reservoir beyond an amount recoverable by a primary means. Utilizing a water flooding method in such a post-primary recovery process may involve injecting water into an injector well leading to a subterranean formation containing a subterranean petroleum reservoir to displace petroleum through the subterranean formation to a production well. However, using water in a post-primary water flooding process does not displace petroleum efficiently because oil and water are immiscible and the interfacial tension between water and oil is relatively high. After completion of a post-primary oil recovery process using water flooding, as much as seventy percent of the oil originally present in a subterranean formation may remain unrecovered in the formation.

Because a post-primary oil recovery process of only water flooding yields just a partial recovery of oil present in the subterranean formation after an initial or primary recovery, surface active agents or surfactants in the flood water of a water flooding process may be utilized to reduce interfacial tension between the injected water and the formation petroleum. Introducing surfactants in the flood water may permit increased recovery of residual oil after primary production than post-primary recoveries using water flooding alone. Some surfactants used in oil recovery operations are limited with respect to formation water salinity and formation water hardness which greatly reduce their applicability and overall effectiveness. For instance, oil recovery effectiveness of surfactant systems may be diminished by the presence of a highly saline environment (i.e., greater than two weight percent total dissolved solids) present in the region of oil to be recovered. This is because high salinity waters within a subterranean reservoir can cause precipitation of surfactants which destroys or greatly reduces their effectiveness in the oil recovery process. A highly saline environment can also diminish the effectiveness of mobility buffers by reducing their viscosity. Thus, although post-primary water flooding, either alone or in conjunction with a surfactant, is a process used to recover residual quantities of oil which remain in subterranean formations after primary oil recovery, such processes tend to be expensive relative to their effectiveness.

Thus, a need exists for more effective and economical post-primary oil recovery processes applicable to subterranean oil-bearing formations containing relatively high salinity, relatively high temperature and relatively hard water.

### SUMMARY OF THE DISCLOSURE

A post-primary process for the displacement and recovery of oil from a subterranean formation may entail injecting into a crude oil-bearing subterranean formation an aqueous saline surfactant composition comprising (1) brine, (2) Alkyl Polyglucoside, (3) Linear Primary Alcohol Ethoxylate, (4) sodium hydroxide and (5) alcohols; displacing the aqueous composition through the oil-bearing formation and driving oil from the oil-bearing formation; and recovering oil displaced from the subterranean formation. The injecting step may be preceded by the step of injecting into the subterranean formation a volume of salinity water to adjust salinity of connate water within the subterranean reservoir to a predetermined value of salinity. Injection of the surfactant composition in step (a) may be followed by injection of a buffer comprising water dispersible polymeric viscosifier. Injection of the surfactant composition may be followed by injection of a buffer comprising water soluble polymeric viscosifier. The surfactant composition additionally may contain at least one cosurfactant selected from hydrocarbon sulfonates and alcohols.

### BRIEF DESCRIPTION OF THE DRAWINGS

A more complete understanding of the present disclosure and benefits thereof may be acquired by referring to the following description taken in conjunction with the accompanying drawings in which:

FIG. 1 is a diagram of a subterranean formation depicting an oil reservoir;

FIG. 2 is an example imbibition test cell for a surfactant system; and

FIG. 3 is a graph depicting test results of surfactant systems.

### DETAILED DESCRIPTION

Turning now to the detailed description of the present disclosure, inventive features and concepts may be manifested in other arrangements. Thus, the scope of the disclosure is not intended to be limited to embodiments and examples described below or to that depicted in any figures.

In accordance with the present disclosure, an aqueous saline surfactant system may contain a predetermined concentration or weight percentage of SCHMOO-B-GONE SURFACTANT® and a predetermined concentration or weight percentage of normal brine. The aqueous saline surfactant system may optionally contain a protective agent. As an example, Ethoxylated sulfosuccinate derivatives, e.g., diesters and half-esters of alpha-sulfosuccinic acid and ethoxylated alcohols may be added as phase stabilizing agents to aqueous saline solutions of petroleum sulfonates to substantially reduce or to eliminate phase separation and/or precipitation of a surfactant and/or a cosurfactant in such solutions upon their contact with hard brines, which may contain high concentrations of divalent ions such as CA++ and Mg++.

SCHMOO-B-GONE SURFACTANT® is a commercially available dispersing surfactant composition in an alkaline base used to emulsify and disperse hydrocarbons. SCHMOO-B-GONE SURFACTANT® may have a composition of Alkyl Polyglucoside (e.g. 4-20%), Linear Primary Alcohol Ethoxylate (e.g. 1-15%), Sodium Hydroxide (NaOH) (e.g. 4-30%), and may contain a mixture of alcohols (e.g. 0-25%). A variety of combinations of composition components of SCHMOO-B-GONE SURFACTANT® within the specified percentage ranges, or outside or beyond the specified percentage ranges, are conceivable. Percentages may be weight percentages.

### Cosurfactants

A cosurfactant may be used in conjunction with SCHMOO-B-GONE SURFACTANT®, which may be a primary surfactant, in a surfactant system of the present disclosure. One cosurfactant that may be used in the surfactant system of the present disclosure may broadly be a hydrocarbon sulfonate surfactant having an equivalent weight from 225 to 600. Examples of hydrocarbon sulfonates include, olefin sulfonates, alkyl sulfonates and Petroleum sulfonates, which may be commercially available. Moreover, a cosurfactant that may be utilized in post-primary oil recovery may be a petroleum sulfonate having an average equivalent weight in the range of 325 to 600.

Another cosurfactant that can be used in the surfactant system of this disclosure may be saturated or unsaturated alcohols having 1-12 carbon atoms per molecule or alcohols of 4-20 carbon atoms per molecule which have been ethoxylated or propoxylated with an average of 1 to about 12 ethylene oxide or propylene oxide units per molecule, or mixtures of two or more of the alcohols described above.

Other cosurfactants that may be used in the surfactant system of the present disclosure may be polar organic compounds, such as primary, secondary, or tertiary amines having 1-12 carbon atoms per molecule, phenol or phenols having a side chain of 1-10 carbon atoms per molecule, ketones having 3-12 carbon atoms per molecule, mecaptans having 2-12 carbon atoms per molecule, glycols having 2-18 carbon atoms per molecule, glycerols having 3-18 carbon atoms per molecule, aldehydes having 2-12 carbon atoms per molecule, amides having 1-8 carbon atoms per molecule, nitriles having 2-8 carbon atoms per molecule, and sulfoxides or sulfone having 2-12 carbon atoms per molecule. Also, an example cosurfactant may be a phenol, amine, mercaptan, glycol, or amide of 1-20 carbon atoms per molecule which have been ethoxylated or propoxylated with an average of 1-12 ethylene oxide or propylene oxide units per molecule.

The cosurfactant may be an alcohol having 3-8 carbon atoms per molecule and may be soluble to an appropriate degree in both water and oil. Examples of saturated alcohols, having 4 to 6 carbon atoms, include isobutyl alcohol, isoamyl alcohol, n-amyl alcohol, and n-hexyl alcohol. When an alcohol is to be selected for oil within a particular subterranean formation, the shorter chain alcohols may generally be found suitable for oils containing high molecular weight carboxylic acids, with the longer chain alcohols more suitable for oils containing lower molecular weight carboxylic acids.

### Oil Recovery Process

An oil recovery process using a surfactant system constitutes another embodiment of this disclosure. Such an oil recovery process may include one or more conventional steps of a post-primary oil recovery process but distinguish over known procedures as least because SCHMOO-B-GONE SURFACTANT® is used as part of an admixture with alcohols, which may be used as cosurfactants.

### Preflush

A preflush step optionally may be incorporated into a method of improving enhanced oil recovery using a surfactant system as disclosed herein and may precede or be part of the post-primary oil recovery operation. Generally, brine compatible with the surfactant system is injected via at least one injection well into the subterranean formation. Such brine may contain 2,000-50,000 ppm salts. In one example, such salts may be predominantly sodium chloride. A brine solution may be utilized in the production of the surfactant system in this preflush step.

The quantity of the preflush employed may be in a range of about 0.01 to 2, preferably 0.25 to 1 pore volume, based on the total pore volume of the subterranean formation/reservoir subjected to recovery efforts.

### Surfactant Flooding

After an optional preflush step, the surfactant fluid of the present disclosure may be injected into the subterranean reservoir via at least one injection well. The surfactant system may be injected in an amount in the range of about 0.001 to 1.0, preferably 0.01 to 0.25 pore volume based on the pore volume of the total treated and produced formation.

An aqueous saline surfactant system of the present disclosure may be in the form of a single phase and may contain brine, acylated polypeptide surfactant and at least one cosurfactant, e.g., sulfonate and/or alcohol, as the principal ingredients. The single phase surfactant system may be introduced into the formation via one or more injection wells, either in such injection wells at separate or different times or simultaneously at the same time. Generation of a microemulsion may take place in-situ as the injected surfactant system contacts oil in place within a subterranean reservoir. It is contemplated that surfactant systems characterized by the presence of more than one phase are preferably subjected to continuous mixing during the injection operation.

Teachings of the present disclosure may be utilized for a variety of subterranean reservoirs, including reservoirs containing hard brine connate water. Such hard brines are characterized by a high content of Mg++ and Ca++ ions in subterranean reservoir water. Typical hard brines may contain more than 100 ppm of Ca++ and/or Mg++.

Protective agents may be used as an ingredient in a surfactant system in accordance with the present disclosure, such as when a surfactant system is used for oil recovery from subterranean reservoirs with hard brines. Protective agents aid in solubilizing, or making soluble, the surfactant in a high salinity environment. Examples of such protecting agents are polyethoxylated fatty alcohols and polyethoxylated alkylphenols. Sodium salts of sulfated polyethoxylated fatty alcohols and polyethoxylated alkylphenols are known in the art to function as protective agents.

A post-primary recovery process may include steps as known from a micellar-polymer flooding process, may include fewer or greater steps as compared to that of a micellar-polymer flooding process, or may include steps that are in one or more aspects different from that of a micellar-polymer flooding process. Steps in accordance with the present disclosure may also be omitted from that of a micellar-polymer flooding process. Thus, a post-primary recovery process may include a preflush solution being introduced into a subterranean reservoir such that a volume of brine is injected or introduced to lower salinity of a volume of brine already resident in the subterranean reservoir. A preflush may range from 0 to 100% pore volume (PV) and more than one may be utilized in a recovery process. An agent may be added to lessen surfactant retention. In a separate step, a slug of a main or sole surfactant may be added and optionally, other chemicals may be added in this step or subsequent to this step. In another step, a mobility buffer may be added. In one example, a mobility buffer may be a fluid that is a dilute solution of a water-soluble polymer whose purpose is to drive the slug and banked-up fluids towards one or more production wells. Buffer volumes may range from 0 to 100% pore volume (PV). A step of adding or introducing a mobility buffer taper into the subterranean reservoir may be utilized such that a volume of brine may be introduced or injected into a subterranean reservoir. The volume of brine may contain a dilute polymer added to it to produce a gradual change, which is a taper, in polymer concentration from an original mobility buffer concentration down to zero concentration. A step of adding or introducing chase water may be utilized in which a fluid is injected to reduce the cost of a continuous injection of polymer.

### Mobility Buffer

Either as a step immediately after introducing a surfactant slug, or at some step subsequent to adding or introducing a surfactant slug into a subterranean reservoir, a mobility buffer solution may be injected or introduced into the subterranean reservoir. A mobility buffer solution prevents or largely prevents fingering and enhances the efficiency of a post-primary oil recovery process. Examples of useful mobility buffers are aqueous solutions of thickening agents and nonaqueous fluids containing mobility reducing agents such as high molecular weight partially hydrolyzed polyacrylamides, biopolysaccharides, cellulose ethers and the like. The mobility buffer may contain 50 to 20,000 ppm, and preferably 200 to 5,000 ppm, of a mobility reducing agent in the fluid.

The injection of the mobility buffer fluid can be at a constant composition or the mobility buffer can be graded, i.e., the injection may begin at a relatively high concentration of mobility reducing agent at the leading edge and the concentration of the agent may over some predetermined time period taper off toward the trailing edge. As an example, the mobility buffer can start with a concentration of 2500 ppm of polyacrylamide in water and end with 250 ppm of polyacrylamide in water.

A suitable drive fluid can be injected into the formation subsequent to injection of the surfactant system or following the mobility buffer injection. The drive fluid may be fresh water, salt water of a predetermined concentration, brine of a predetermined or known concentration, or one or more other aqueous fluids compatible with an oil-bearing formation as known to those skilled in the art.

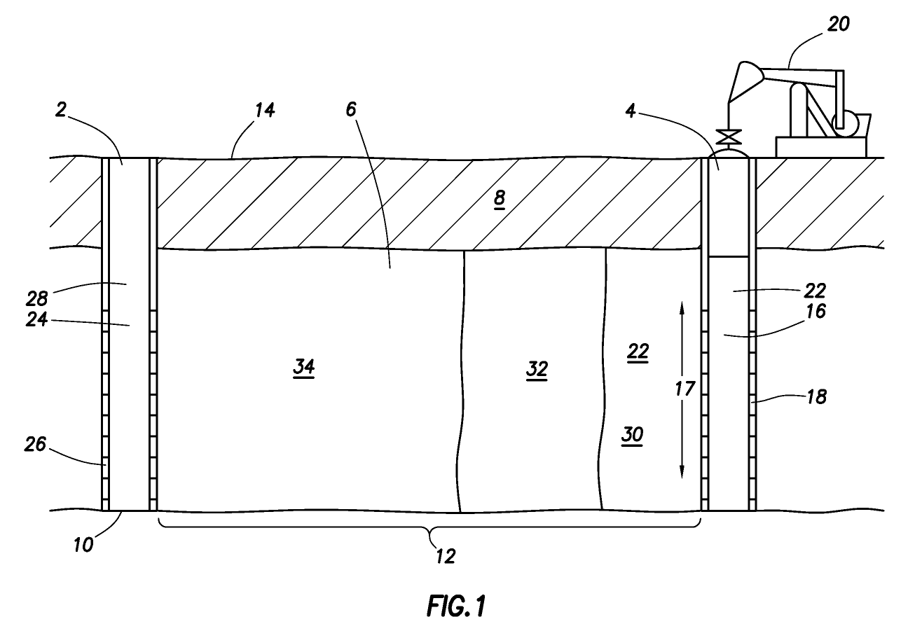

In one example application of the present disclosure, FIG. 1 depicts an enhanced oil recovery scenario in which an injector well 2 is located in proximity to a production well 4. Both wells 2, 4 are drilled into a permeable subterranean formation 6, which may contain an underground oil reservoir 12 and may extend from an overburden layer 8 to an underburden layer 10. While wells 2, 4 depicted in FIG. 1 are substantially vertical, other well configurations, including wells forming various angles with an outer or top surface 14 of the Earth are within the scope of this disclosure. Additionally, within the context of this disclosure, the term “injector well” is defined broadly to include any channel, tunnel or hole, either man-made or naturally occurring, of sufficient size and location with respect to a reservoir to facilitate methods herein described.

As depicted in FIG. 1, a borehole 16 of production well 4 may be supported by a perforated casing 18, and a pump 20 located on surface 14 may be used to extract oil 22 that flows into borehole 16 through perforated casing 18 from subterranean formation 6. A borehole 24 of injection well 2 may have a perforated casing 26 to permit fluids 28 injected into injection well 2 to flow into subterranean formation 6. Injector well 2 may be located some distance away from production well 4, such as 400 ft as an example. However, in all instances injector well 2 will be a distance from production well 4 that supports facilitation of steps of methods and processes for enhancing extraction of oil from subterranean oil reservoir 12 of subterranean formation 6. Subterranean oil reservoir 12 may be resident within and may be part of subterranean formation 6, which generally resides between injector well 2 and production well 4, as depicted in FIG. 1.

In an example, characteristics of subterranean formation 6 between wells 2 and 4 may be summarized as follows: subterranean formation 6 may be primarily sand with a permeability of about 1 Darcy; a reservoir pay zone 17 within subterranean formation 6 may have a vertical range of about 10 to 200 ft; an ambient temperature of subterranean formation 6 may be about 100 degrees Celcius; the average pressure of subterranean oil reservoir 12 within subterranean formation 6 may be about 4000 psi; and oil within oil reservoir 12 may be generally sweet with an average viscosity varying from 2 to 80 Centipoise. In one example, subterranean formation 6 may be generally divided into three zones. A zone that is an oil bank 30, a zone that is connate water 32 and a zone that is a liquid bank 34. Liquid bank 34 may be a bank constituting a variety of chemicals, which may be adjusted depending upon the chemistry of connate water 32 and chemistry of oil bank 30. Liquid bank 34 may be an injected bank of fluid, such as water to drive connate water 32 and oil bank 30 into production well 4.

In accordance with the present disclosure, to enhance recovery of oil 22 from oil bank 30 of subterranean formation 6, an injection of fluids to maintain pressure of oil reservoir 12 within subterranean formation 6 may be accomplished by injecting fluids that comprise liquid bank 34. Fluid banks 30, 32, 34 are typically in the arrangement depicted in FIG. 1 such that fluid bank of connate water 32 is ahead of liquid bank 34, and banks 32, 34 are behind oil bank 30 in a direction from injector well 2 to recovery well 4. Water and SCHMOO-B-GONE SURFACTANT® may be injected into injector well 2 in a post-recovery oil process as part of liquid bank 34. Thus, as liquid bank 34 is injected into subterranean formation 6, liquid bank 34, bank of connate water 32 and oil bank 30 sweep across subterranean formation 6 from injector well 2 to production well 4 thus forcing oil 22 from oil bank 30 into bore hole 16 and from production well 4.

In accordance with teachings of the present disclosure, various concentrations of SCHMOO-B-GONE SURFACTANT®, as revealed above, may be injected into injector well 2 as part of liquid bank 34. Such an injection is not only part of a pressurizing process within subterranean formation 6 and an overall sweeping process of subterranean formation 6 to push or force oil toward production well 4, but because SCHMOO-B-GONE SURFACTANT® is a surfactant, interfacial tension between oil and solid geographic formations (e.g. rock, sand, etc.) and/or between oil and other liquids within subterranean formation 6 are reduced or eliminated. SCHMOO-B-GONE SURFACTANT® reduces the surface tension of water by adsorbing at the liquid-gas interface and reduces the interfacial surface tension between oil and water by adsorbing at the liquid-liquid interface. SCHMOO-B-GONE SURFACTANT® may also form an aggregate, such as a micelles, in a solution containing water (e.g. brine, connate water or water added as part of an injection process to injector well 2). Brine may be salt water trapped or mixed with oil in a subterranean oil reservoir. SCHMOO-B-GONE SURFACTANT® may be mixed with brine to achieve an optimal ratio of SCHMOO-B-GONE SURFACTANT® to brine to achieve optimal performance of oil removal from subterranean reservoir 6. SCHMOO-B-GONE SURFACTANT® may form molecules having a strong polar “head” and a non-polar hydrocarbon chain or “tail.” When this type of molecule is added to water, the non-polar tails of the molecules may clump into the center of a ball-like structure, (e.g. a micelle). Because they are hydrophobic or “water hating,” the polar head of the molecule presents itself for interaction with the water molecules on the outside of the micelle.

Thus, SCHMOO-B-GONE SURFACTANT® may be mixed with normal brine found within an oil reservoir to be swept. The concentrations, weight percentages, levels or mixture ratios of components of SCHMOO-B-GONE SURFACTANT® may be adjusted to an optimized level by conducting an imbibition test. In one example of an imbibition test, a cylindrical sample of sandstone may be placed inside an imbibition cell through an open bottom, which is then sealed shut. The sandstone may be that found within a subterranean formation to ensure an accurate test. Then, imbibition cell may be filled with SCHMOO-B-GONE SURFACTANT® and brine, and then sealed. Because oil is originally resident within the sandstone within the imbibition cell, the SCHMOO-B-GONE SURFACTANT® within the solution of brine provokes a continual extraction of oil from the sandstone. Upon exiting the sandstone, released oil migrates to the surface of the brine within the bottle due to its relative lower density. The volume of oil upon the surface may be measured over time to determine rates of release, and a total volume of oil extracted from a sandstone sample may be calculated. Sandstone is used in this disclosure as an example, and whatever geographic or rock formation is within an actual subterranean reservoir may be tested in the above-described example.

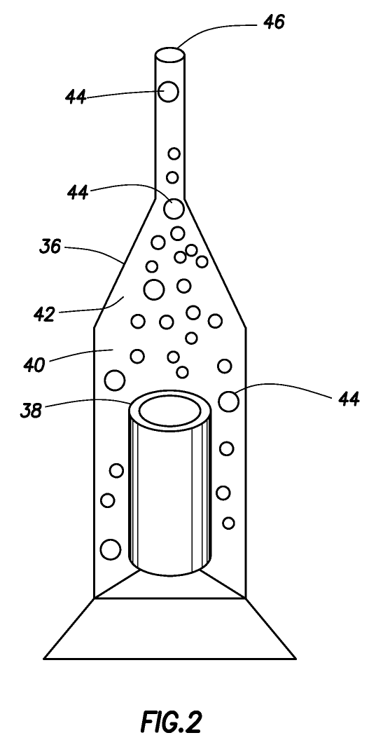

FIG. 2. depicts an example imbibition test utilizing an imbibition cell 36 within which a subterranean sample 38, such as rock, packed sand, etc. may be placed. As an example, subterranean sample 38 may be a 1.5″ diameter by 3″ long sample representative of a subterranean soil sample, or may actually be a sample of actual subterranean soil, rock, etc. from an actual subterranean formation to undergo sweeping, such as from subterranean formation 6. An internal volume 40 of imbibition cell 36 may be initially filled with a measured volume (i.e. weight percentage) of SCHMOO-B-GONE SURFACTANT® and a measured volume (i.e. weight percentage) of brine, such as a sample of brine from the subterranean formation to undergo sweeping. Upon surrounding subterranean sample 38 with brine, an aqueous phase 42 containing brine, SCHMOO-B-GONE SURFACTANT® and oil will become evident in internal volume 40. Because oil is less dense than other components within imbibition cell 36, as oil molecules 44 are released from attachment to subterranean sample 38 by SCHMOO-B-GONE SURFACTANT®, oil molecules 44 migrate toward an upper end 46 of imbibition cell 36. An optimum extraction rate of oil from subterranean sample 38 may vary depending upon the economic evaluation of a reservoir to be swept. That is, a higher weight percentage of SCHMOO-B-GONE SURFACTANT® relative to brine may be warranted in an injection via injector well 2 as the market price per barrel of crude oil increases; therefore, economics may factor into a concentration of SCHMOO-B-GONE SURFACTANT® relative to brine. SCHMOO-B-GONE SURFACTANT® may be diluted with alcohol(s) (i.e. considered part of the composition of SCHMOO-B-GONE SURFACTANT®) before being mixed with brine to arrive at an optimal oil extraction mixture for a given subterranean formation 6. That is, as an example, SCHMOO-B-GONE SURFACTANT® may have a composition of Alkyl Polyglucoside (e.g. 10%), Linear Primary Alcohol Ethoxylate (e.g. 10%), Sodium Hydroxide (NaOH) (e.g. 20%), and may contain a mixture of alcohols (e.g. 20%). Concentrations or weight percentages of component parts of SCHMOO-B-GONE SURFACTANT® may be adjusted to arrive at a 100% total composition of component parts.

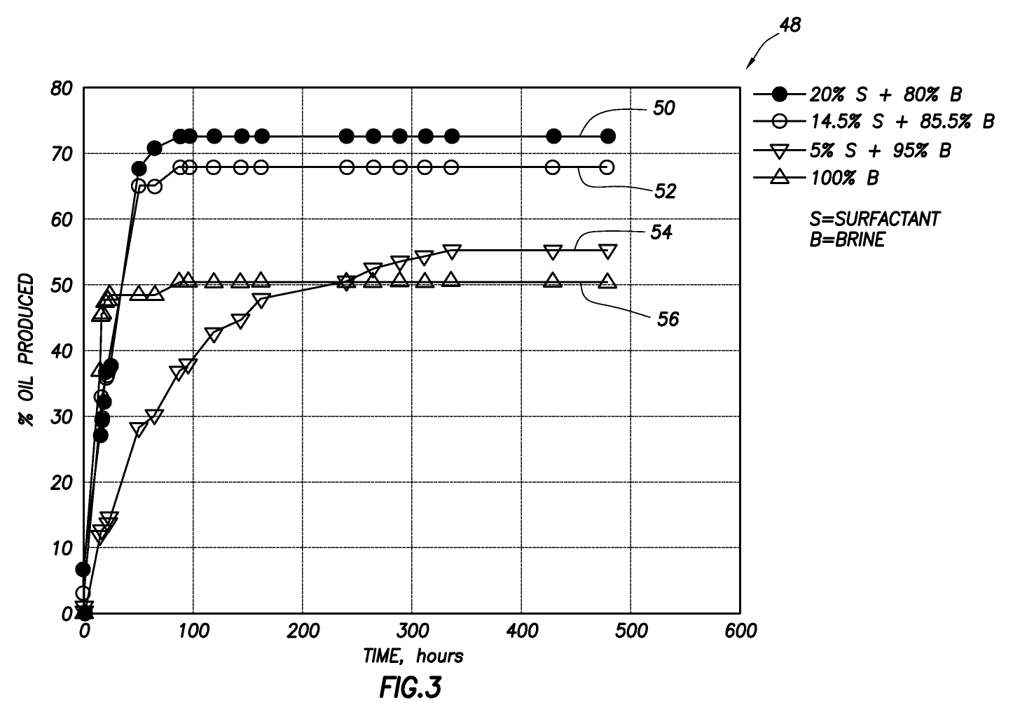

FIG. 3 is a graph 48 depicting imbibition test results of four imbibition tests. Each plot of each test employed a different surfactant composition. More specifically, test graph 48 depicts plots of percentage of oil in place produced versus a linear scale of time, in hours. The vertical axis of graph 48 represents a measure of oil recovered in a post-primary oil recovery operation as a percentage of the volume of oil originally recovered in a primary recovery operation. With reference to graph 48, for a given subterranean formation, plot 50 represents oil recovered in a post-primary oil recovery operation as a percentage of the volume of oil originally recovered in a primary recovery operation for a surfactant system that is 20% by weight percentage of SCHMOO-B-GONE SURFACTANT® and 80% by weight percentage of brine; plot 52 represents the oil recovered in a post-primary oil recovery operation as a percentage of the volume of oil originally recovered in primary recovery operation for a surfactant system that is 14.5% by weight percentage of SCHMOO-B-GONE SURFACTANT® and 85.5% by weight percentage of brine; plot 54 represents the oil recovered in a post-primary oil recovery operation as a percentage of the volume of oil originally recovered in primary recovery operation for a surfactant system that is 5% by weight percentage of SCHMOO-B-GONE SURFACTANT® and 95% by weight percentage of brine; and plot 56 represents the oil recovered in a post-primary oil recovery operation as a percentage of the volume of oil originally recovered in primary recovery operation for a surfactant system that is 100% by weight percentage of brine.

With continued reference to plot 48, one may conclude that plot 50 and plot 52 indicate that a full or complete volume of post oil recovery has been reached after 100 hours has elapsed. The same or similar conclusion may be drawn for plot 56, which represents a post-primary recovery fluid (i.e. a drive fluid) of 100% of brine. That is, for plot 56 after approximately 100 hours, using brine as a post-primary recovery fluid, a maximum percentage of oil recovered is reached. Plot 54 depicts continued recovery of oil from a subterranean reservoir in a post-primary recovery process until just after 300 hours have elapsed. Thus, by using a surfactant system of 5% by weight of SCHMOO-B-GONE SURFACTANT® and 95% by weight of brine, a post-primary volume of oil exceeding 50% of that extracted in a primary recovery process, may be achieved. Using brine alone, as plot 56 indicates, results in less oil recovery than that of plot 50, which utilizes 20% SCHMOO-B-GONE SURFACTANT® and plot 52, which utilizes 14.5% SCHMOO-B-GONE SURFACTANT®.

A post-primary process for the displacement and recovery of oil from a subterranean formation may entail injecting, into a crude oil-bearing subterranean formation, an aqueous saline surfactant composition comprising (1) brine, (2) Alkyl Polyglucoside, (3) Linear Primary Alcohol Ethoxylate, (4) sodium hydroxide and (5) alcohols; displacing the aqueous composition through the oil-bearing formation and driving oil from the oil-bearing formation; and recovering oil displaced from the subterranean formation. The injecting step may be preceded by the step of injecting into the subterranean formation a volume of salinity water to adjust salinity of connate water within the subterranean reservoir to a predetermined value of salinity. Injection of the surfactant composition in step (a) may be followed by injection of a buffer comprising a water dispersible polymeric viscosifier. Injection of the surfactant composition may be followed by injection of a buffer comprising water soluble polymeric viscosifier(s). The surfactant composition additionally may contain at least one cosurfactant selected from hydrocarbon sulfonates and alcohols.

In another example, a post-primary process for the displacement and recovery of oil from a subterranean formation penetrated by at least one injection well and by at least one production well may include the steps of: (a) injecting into a crude oil-bearing subterranean formation an aqueous saline surfactant composition comprising (1) brine, (2) Alkyl Polyglucoside, (3) Linear Primary Alcohol Ethoxylate, (4) sodium hydroxide and (5) alcohols; (b) thereafter displacing the aqueous composition through the oil-bearing formation and driving oil from the oil-bearing formation; and (c) recovering oil displaced from the subterranean formation through the production well. The at least one injection well and the at least one production well may be physically separate from each other and may each provide an access passage between the subterranean formation and a surface of the Earth. Step (a) may be preceded by a step of injecting, into the subterranean formation through the injection well, a preflush comprising a quantity of low salinity water to adjust the salinity of connate water to a predetermined value. Step (a) may further involve injecting an aqueous saline surfactant composition comprising (1) 80% brine by weight percent, or step (a) may further involve injecting an aqueous saline surfactant composition comprising (1) 80% brine by weight percent, and 20% by weight percent of the following enumerated (2)-(5): (2) Alkyl Polyglucoside, (3) Linear Primary Alcohol Ethoxylate, (4) sodium hydroxide and (5) alcohols. Step (a) may be conducted for a period of at least 100 hours.

In another example, a post-primary oil recovery process for recovering a hydrocarbon from a subterranean formation may include the steps of: (a) injecting into a crude oil-bearing subterranean formation via an injection well, an aqueous saline surfactant composition comprising: component (1) which may be at least 80% by weight percent of brine, and components (2) through (5) which respectively, may comprise: (2) Alkyl Polyglucoside, (3) Linear Primary Alcohol Ethoxylate, (4) sodium hydroxide and (5) alcohols. Because components (2) through (5) may total 20% by weight percent, together components (1) brine and components (2) through (5) may total 100% by weight percent. The process may further comprise: (b) injecting water with the aqueous saline surfactant composition and displacing the aqueous saline surfactant composition through the subterranean formation and driving oil from the subterranean formation, and (c) recovering oil displaced from the subterranean formation through a production well. Step (a) may be preceded by the step of injecting into the subterranean formation through the injection well a preflush comprising a quantity of low salinity water and adjusting the salinity of connate water to a predetermined value. Step (a) may further comprise injecting an aqueous saline surfactant composition comprising (1) 95% by weight percent of brine and components (2) through (5) to total 100% by weight percent. Components (2) through (5) may comprise: (2) Alkyl Polyglucoside, (3) Linear Primary Alcohol Ethoxylate, (4) sodium hydroxide and (5) alcohols, to total 100% weight percent. Step (a) may include injecting an aqueous saline surfactant composition comprising (1) 5% by weight percent of the following enumerated (2)-(5): (2) Alkyl Polyglucoside, (3) Linear Primary Alcohol Ethoxylate, (4) sodium hydroxide and (5) alcohols. The post oil recovery process may include conducting step (a) for a time period of at least 10 hours.

The post-primary oil recovery processes described above may be performed in alphabetic order as noted above, or they may be performed in non-alphabetic order. Thus, combinations of steps as described above, forming a process for the recovery of oil from subterranean oil-bearing formations, exhibits improved oil recovery efficiency, is effective for post-primary oil recovery, is financially economical in operation and is uncomplicated in execution. Included in the disclosure is an enhanced post-primary oil recovery process or method where water containing chemicals, sulfonates and polymers may be injected into a subterranean reservoir to reduce the surface tension of oil clinging to porous rock, thus freeing the oil so that it may be recovered to the outer surface of the Earth. At the same time, each and every claim below is hereby incorporated into this detailed description or specification as additional embodiments of the present invention.

Although the systems and processes described herein have been described in detail, it should be understood that various changes, substitutions, and alterations can be made without departing from the spirit and scope of the invention as defined by the following claims. Those skilled in the art may be able to study the preferred embodiments and identify other ways to practice the invention that are not exactly as described herein. It is the intent of the inventors that variations and equivalents of the invention are within the scope of the claims while the description, abstract and drawings are not to be used to limit the scope of the invention. The invention is specifically intended to be as broad as the claims below and their equivalents.

What is claimed is:

1. A post-primary process for the displacement and recovery of oil from a subterranean formation comprising the steps of:
(a) injecting into a crude oil-bearing subterranean formation an aqueous saline surfactant composition comprising (1) brine, (2) Alkyl Polyglucoside, (3) Linear Primary Alcohol Ethoxylate, (4) sodium hydroxide and (5) alcohols;
(b) thereafter displacing the aqueous composition through the oil-bearing formation and driving oil from the oil-bearing formation; and
(c) recovering oil displaced from the subterranean formation.

2. The process according to claim 1, wherein the injecting step (a) is preceded by the step of:
injecting into the subterranean formation a volume of salinity water to adjust salinity of connate water within the subterranean reservoir to a predetermined value of salinity.

3. The process according to claim 2, wherein injection of the surfactant composition in step (a) is followed by injection of a buffer comprising water dispersible polymeric viscosifier.

4. The process according to claim 2, wherein injection of the surfactant composition in step (a) is followed by injection of a buffer comprising water soluble polymeric viscosifier.

5. The process according to claim 2, wherein the surfactant composition additionally contains at least one cosurfactant selected from hydrocarbon sulfonates and alcohols.

6. A post-primary process for the displacement and recovery of oil from a subterranean formation penetrated by at least one injection well and by at least one production well, the post-primary process comprising the steps of:
(a) injecting into a crude oil-bearing subterranean formation an aqueous saline surfactant composition comprising (1) brine, (2) Alkyl Polyglucoside, (3) Linear Primary Alcohol Ethoxylate, (4) sodium hydroxide and (5) alcohols;
(b) thereafter displacing the aqueous composition through the oil-bearing formation and driving oil from the oil-bearing formation; and
(c) recovering oil displaced from the subterranean formation through the production well.

7. The process according to claim 6, wherein the at least one injection well and the at least one production well are physically separate access passages between the subterranean formation and a surface of the Earth.

8. The process according to claim 7, wherein step (a) is preceded by the step of injecting into the subterranean formation through the injection well a preflush comprising a quantity of low salinity water so as to adjust the salinity of connate water to a predetermined value.

9. The process according to claim 6, wherein step (a) further comprises injecting an aqueous saline surfactant composition comprising (1) 80% brine by weight percent.

10. The process according to claim 6, wherein step (a) further comprises injecting an aqueous saline surfactant composition comprising (1) 80% brine by weight percent and 20% by weight percent of the following enumerated (2)-(5): (2) Alkyl Polyglucoside, (3) Linear Primary Alcohol Ethoxylate, (4) sodium hydroxide and (5) alcohols.

11. The process according to claim 6, further comprising conducting step (a) for a period of at least 100 hours.

12. A post-primary oil recovery process for recovering a hydrocarbon from a subterranean formation, the post-primary oil recovery process comprising the steps of:
(a) injecting into a crude oil-bearing subterranean formation via an injection well, an aqueous saline surfactant composition comprising (1) at least 80% by weight percent of brine, and components (2) through (5) to total 100% by weight percent, wherein components (2) through (5) comprise: (2) Alkyl Polyglucoside, (3) Linear Primary Alcohol Ethoxylate, (4) sodium hydroxide and (5) alcohols, to total 100% weight percent;
(b) injecting water with the aqueous saline surfactant composition and displacing the aqueous saline surfactant composition through the subterranean formation and driving oil from the subterranean formation; and
(c) recovering oil displaced from the subterranean formation through a production well.

13. The process according to claim 12, wherein step (a) is preceded by the step of injecting into the subterranean formation through the injection well a preflush comprising a quantity of low salinity water and adjusting the salinity of connate water to a predetermined value.

14. The process according to claim 13, wherein step (a) further comprises injecting an aqueous saline surfactant composition comprising (1) 95% by weight percent of brine and components (2) through (5) to total 100% by weight percent, wherein components (2) through (5) comprise: (2) Alkyl Polyglucoside, (3) Linear Primary Alcohol Ethoxylate, (4) sodium hydroxide and (5) alcohols, to total 100% weight percent.

15. The process according to claim 14, wherein step (a) further comprises injecting an aqueous saline surfactant composition comprising (1) 5% by weight percent of the following enumerated (2)-(5): (2) Alkyl Polyglucoside, (3) Linear Primary Alcohol Ethoxylate, (4) sodium hydroxide and (5) alcohols.

16. The process according to claim 15, further comprising:
conducting step (a) for a time period of at least 25 hours.
